(19) United States
(12) Patent Application Publication
(10) Pub. No.: US 2007/0271145 A1
(43) Pub. Date: Nov. 22, 2007

(54) Consolidated System for Managing Internet Ads

(76) Inventor: Herb D. Vest, Dallas, TX (US)

Correspondence Address: CARSTENS & CAHOON, LLP, P O BOX 802334, DALLAS, TX, 75380, US

(21) Appl. No.: 11/755,641

(22) Filed: May 30, 2007

Related U.S. Application Data
(63) Continuation-in-part of application No. 10/928,063, filed on Aug. 27, 2004.
(60) Provisional application No. 60/589,336, filed on Jul. 20, 2004.

(51) Int. Cl. G06Q 30/00

(52) U.S. Cl. 705/14

(57) ABSTRACT

An improved system for managing online advertising inventory and advertisement creatives. The system provides a central database where an entire advertising campaign's metric data is maintained for easy review. The metric data is accessible through a common, collaborative user interface. The interface allows publishers and advertisers to access their respective metric data. A publisher can review metric data associated with its inventory and make inventory pricing determinations. An advertiser can review metric data associated with its advertising campaign to determine effectiveness. Advertisers can establish prioritization criteria or allow automatic creative priority optimization. The publisher posts inventory for sale in an auction format. Advertisers view the posted inventory and place bids to purchase it. Performance data is maintained relating to elements of creatives and the respective placements. A single tracking asset allows the system to accurately determine which one of multiple publishers receives credit for user action related to the creative.

### CROSS-REFERENCE TO RELATED APPLICATIONS

This application is a continuation-in-part of prior application Ser. No. 10/928,063 filed Aug. 27, 2004, which claims the benefit of provisional Application No. 60/589,336 filed Jul. 20, 2004.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to Internet advertising systems. More specifically, it relates to a consolidated system and accompanying method for improving the management of internet ad buys.

2. Description of Related Art Including Information Disclosed Under 37 CFR 1.97 and 1.98

A typical system used in internet advertising consists of an ad publisher, an ad server, an advertiser, and a user (or visitor) whom the advertiser is trying to reach. The advertiser has ads it wants the user to see, so it contracts with an ad server to place the ads. The ad server also contracts with the publisher to provide the advertiser's ad content for display on the publisher's webpage.

The user visits the publisher's website using a typical internet browser. The browser requests the publisher's webpage. On the webpage are spaces for displaying advertisements (also known as “creatives”). The ad server selects a creative and displays it in the user's browser within the designated ad space on the publisher's webpage.

The publisher (such as YAHOO! or myspace) maintains a webpage with designated spaces on the page for the placement of advertisements. These designated ad spaces are considered the publisher's advertisement “inventory.” This inventory can be extremely valuable depending upon the popularity of the particular publisher's website.

Rates charged by a publisher for its inventory are typically based on a measure of a number of different metrics. These metrics include page impressions, clicks, mouseovers, and direct page visits. Publishers are interested in maintaining accurate accounting using metrics because it allows them to properly price their available inventory. If the metrics indicate that the website is particularly popular, the inventory can be priced relatively high. Conversely, a rarely visited website means that the inventory is not nearly as valuable.

An accurate accounting of metrics for a given webpage and/or advertisement is essential. With an accurate accounting, Advertisers can receive the greatest return on their advertising investment and publishers can ensure higher utilization of their inventory. However, metric data for a complete ad campaign typically resides in more than one location. This requires access to multiple ad servers to obtain a full accounting.

Elements of the key metrics are typically located on the ad server that directly supplies the creatives. However, for a given ad campaign an advertiser may contract with multiple ad servers to host its creatives. Having multiple ad servers typically means multiple publishers are involved in the ad campaign as well. This means that metric data related to the ad campaign is spread across multiple ad servers that serve creatives to multiple publishers. Consequently, for an accurate accounting of the ad campaign metrics, the advertiser must have access to the multitude of ad servers or must request metric reports from multiple publishers. Accessing multiple ad servers can be complicated due to differing passwords, server technologies, and procedures for obtaining the metric accounting. Likewise, accessing multiple publishers can be complicated due to differing response times, report formats, and reporting procedures.

Another problem with current Internet advertising systems is that it is difficult to price inventory accurately. The number of impressions for a given ad/webpage typically fluctuates. For example, a publisher's website may be exceedingly popular between the hours of 10:00 AM to 11:00 AM, but relatively dead for the remainder of the day. Current advertising systems require the publisher to price the inventory based on a static measure of this metric. Thus, the publisher may price the inventory accurately for the busiest time slot but overprice it for the remainder of the day, likely resulting in unused (or unsold) inventory. Conversely, the publisher may price it on an average measure of the metric and lose out on potential inventory revenue it could have earned during the peak impression period.

In addition, current Internet advertising systems allow only static pricing of advertising inventory. For example, a publisher may have inventory that, according to historical metric data, generates a potential 1,000,000 impressions. The publisher might negotiate with an advertiser for a specific price for the 1,000,000 impressions over a given period with the given inventory. However, according to actual metrics, the inventory may generate 1,050,000 impressions over the given period, leaving 50,000 potential impressions unsold. Current systems would allow these 50,000 impressions to remain unsold or incorrectly priced, resulting in lost potential revenue for both publisher and advertiser.

Another problem is that advertisers or agencies who want to track a user's post-click actions must encode their page(s) with a separate tracking asset for each publishing site upon which they advertise. Using an inconspicuous tracking asset (a small requested image URL, or “pixel”, an external IFRAME, or external JavaScript) to record actions that occur after the visitor sees or clicks an ad has been widely practiced for some time. Unlike the present invention, current techniques require the advertiser to place a separate tracking asset on the “completion” page associated with the action (the page representing a successful online purchase, sign-up, etc.) for each of the online publishers' ad server that is serving the ad (the organizations that host Web sites and are contracted to serve the advertiser's ads).

Action tracking relies on the use of Internet cookies to correlate the visitors that view or click specific ads with those that subsequently complete the desired action. As with any application, these cookies are available only to the Web domain that issued them. This requires existing systems to prepare a separate tracking asset for each participating publisher system and place them all into the page source for the action completion page.

Accordingly, a need exists for a consolidated internet advertisement system that maintains all metric data related to a given ad campaign in one location for access by the advertiser even when there are multiple ad servers supporting the ad campaign. Further, a need exists for a system and method that provides for real-time pricing and sales of ad space to allow the most efficient utilization of inventory. Further, a need exists for a system and method that more efficiently prioritizes and optimizes ad placements. Further, a need exists for a system and method that can more efficiently and effectively track ad performance down to individual ad elements. Finally, a need exists for more accurate post-click action tracking that allows a single ad server to determine the exact publisher (of a multitude of publishers) to receive credit for a user's actions. The present invention addresses these needs as well as others which will become apparent to one skilled in the art upon reading and comprehending the detailed description.

### BRIEF SUMMARY OF THE INVENTION

The present invention overcomes many of the disadvantages of prior art by providing a central location to access the metric data necessary for an accurate assessment of the effectiveness of an advertising campaign as well as the value of a publisher's inventory. The advertiser is given access to an administrative database. Using a single interface, the advertiser is allowed to view all of the metrics associated with its advertising campaign regardless of the number of ad servers involved in the ad campaign. The publisher also accesses the same database through a single interface and is allowed to view the metrics associated with its particular inventory usage over multiple ad campaigns. Thus, the present invention includes a common collaborative interface for use by both publishers and advertisers.

In one embodiment, each particular user is granted access to functions particular to the user's role. For example, a publisher is granted access to the system to allow it to view metric data associated with the publisher's registered advertisement inventory. In addition, the publisher is allowed to establish pricing rules relating to the inventory and allow advertisers to place bids on the inventory and to view and approve those bids.

In another embodiment, an advertiser is granted access to the system of the present invention to allow the advertiser to view metric data associated with the ad campaign as it relates to any number of ad servers or publishers. Metric data from each ad server is available on the embodiment for review in a single location. Publishers can also place unsold advertisement inventory up for auction. Advertisers access the system to view and bid on available inventory.

In accordance with another feature of the invention, advertisers access the system to manage all aspects of the advertiser's ad campaigns. Each advertiser can establish rules for ad prioritization within a given ad campaign, and monitor the campaign's effectiveness, and purchase inventory in which to display the ads. Multiple publisher's inventory can be considered, along with the metric data associated with each publisher's respective inventory.

In accordance with another feature of the invention, the system can track performance of various elements in each ad. For example, elements can be specified (such as gender, hair color, car type, etc.) to describe ads. These elements are added to the other performance metrics. Likewise, elements can be added to the placements (such as type of website, demographic, geographic area, etc.). This allows tracking of ad performance within a given placement.

In accordance with another feature of the invention, the system provides a method for single asset tracking. This allows the system to determine which publisher, among multiple publishers, to credit for a visitor's actions relative to an ad placement.

Further objects, features, and advantages of the present invention will become apparent in light of the following detailed description.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1 is a schematic diagram representing a first embodiment of the present invention in its basic form for serving ads over the internet.

FIG. 2 is a schematic diagram representing the layout of an embodiment of the present invention as it is configured to provide a common access point for both advertisers and publishers when a given ad campaign is run on multiple ad servers serving multiple publishers.

FIG. 3 is a flow diagram representing the basic advertisement service and metric data collection process using an embodiment of the present invention;

FIG. 4 is a flow diagram representing the ad campaign configuration steps allowed an advertiser by an embodiment of the present invention;

FIG. 5 is a flow diagram representing an embodiment of the system as it is used to conduct an inventory auction;

FIG. 6 is a flow diagram representing the logic used by the system to determine creative priority in order to build the priority list;

FIG. 7 is a flow diagram representing the logic used by the system to track a visitor's actions relative to a creative that is served by multiple publishers;

FIG. 8 is a flow diagram representing an embodiment of the system as it is used to conduct a reverse-type ad campaign auction; and

FIG. 9 is a flow diagram representing the logic used by the system to determine the creative that is provided as a response to a valid browser request.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

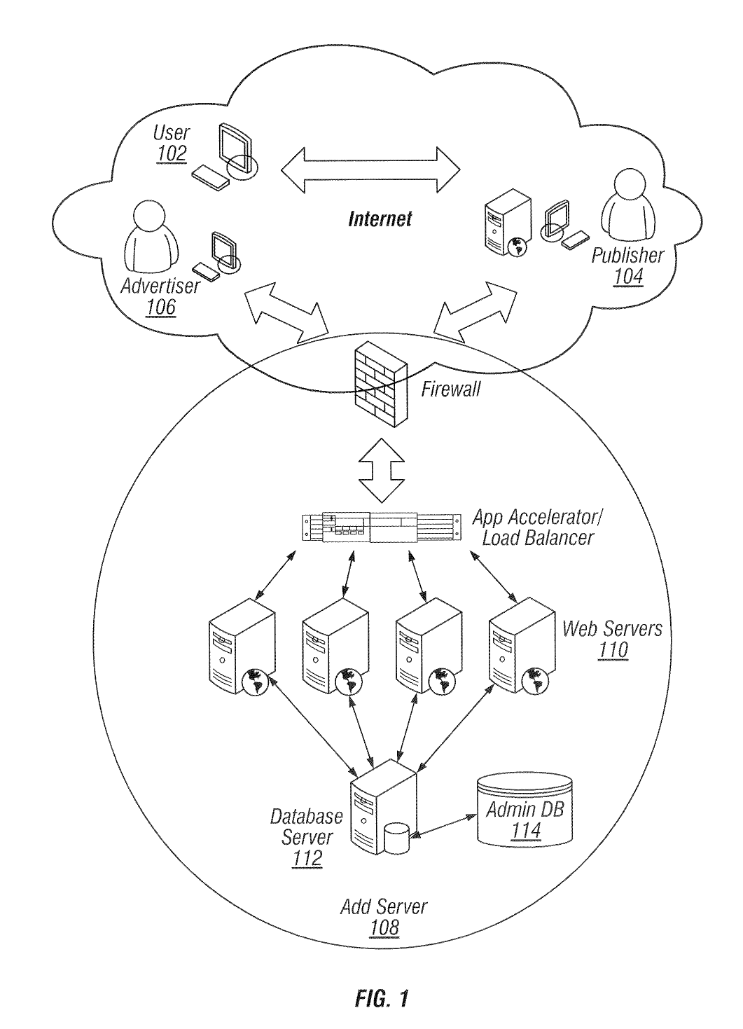

FIG. 1 illustrates a schematic diagram of the basic components of a first embodiment of the present invention as a system for managing online advertising inventory and creatives. The system, in this basic configuration, features a publisher 104; a user 102 (or visitor); an ad server 108; and an advertiser 106. The ad server 108 comprises a database server 112 and corresponding database 114 for storing creative and placement information. The ad server 108 is connected to the internet through a firewall and features multiple web servers for handling a high volume of request hits.

In a generic ad serving system, the user 102 (or visitor) accesses the publisher's website 104 to obtain the publisher's webpage. This webpage consists of designated blank spaces for display of online advertisements. These blank spaces are known as the publisher's advertising “inventory.” The user's browser receives the page and subsequently sends an HTTP request to the ad server 108 for advertising content. The ad server 108 determines which ad (creative) in a given ad campaign to send in response. The user's browser receives the ad and displays it in the respective inventory space on the publisher's webpage.

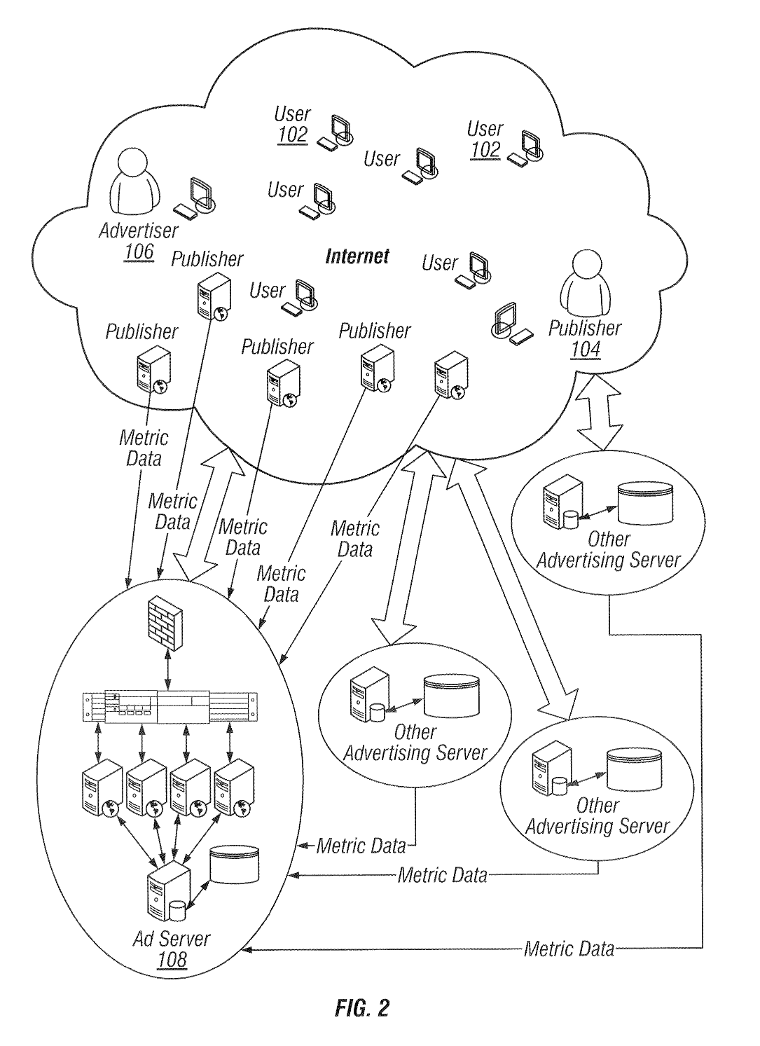

One skilled in the art will appreciate that the basic system shown in FIG. 1 has been distilled for simplification of description. FIG. 2 illustrates a more realistic configuration as would likely be encountered. In this illustration, multiples of each of the earlier elements of the system are shown: users, publishers, advertisers, and ad servers. This figure also illustrates another embodiment of the present invention as it consolidates multiple publisher and ad server metric data in a single location (to be discussed more fully below).

Basic Ad Serving

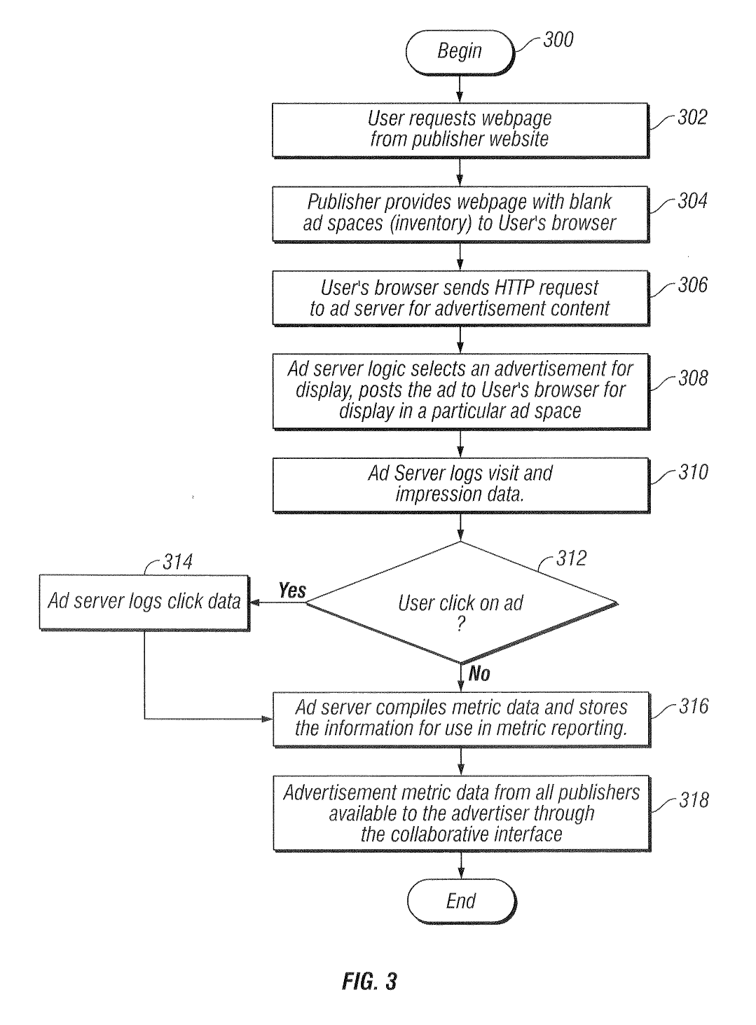

FIG. 3 provides a flow diagram 300 representing detailed steps taken by the present embodiment in displaying creatives to a user 102. The user 102 accesses a publisher's website 104 through an internet connection to request the publisher's webpage (step 302). The publisher 104 sends its requested webpage to the user 102 for display in the user's browser. The actual webpage served by the publisher contains blank spaces within which to display advertisements to the user (step 304).

The user's browser receives the webpage and subsequently sends an HTTP request to the ad server 108 for a creative (step 306). This is typically done using an HTML link request and is performed automatically by the user's browser. The ad server 108 receives this request along with publisher data (such as demographics) and cookie information and utilizes logic to select a creative for display in the user's browser (step 308). The ad server 108 then logs visit and impression data (step 310) related to the placement. If the user clicks on the ad (step 312), the ad server 108 also logs the click data (step 314). The ad server 108 then compiles the metric data and saves it to the database 114 for use in metric reporting (step 316). When multiple publishers and or ad servers are utilized for a given advertising campaign, the ad server 108 rolls-up the related metric data for metric reporting via the ad server's collaborative interface (step 318).

Consolidated Collaborative Interface

One embodiment of the present invention features a consolidated interface for collaboration between advertisers and publishers. For any given ad campaign, much input and configuration is required from both of these parties. For example, a publisher wishes to sell inventory while an advertiser wishes to purchase the inventory in order to market its service or products. The present embodiment allows the publisher and advertiser to access one website (the ad server) to perform these operations.

Using the present embodiment's collaborative interface, the publisher has the greatest amount of control over an ad campaign. The publisher specifies the web pages it has available; the inventory that is available on each web page; how many clicks/impressions the designated campaign will allow; how much it wishes to charge for each bit of inventory (based upon web page metrics—clicks/impressions); and the start/stop dates for the campaign. Thus, the publisher's focus is essentially on its inventory and how much revenue it can generate. The advertiser only has control over the creatives it wishes to show.

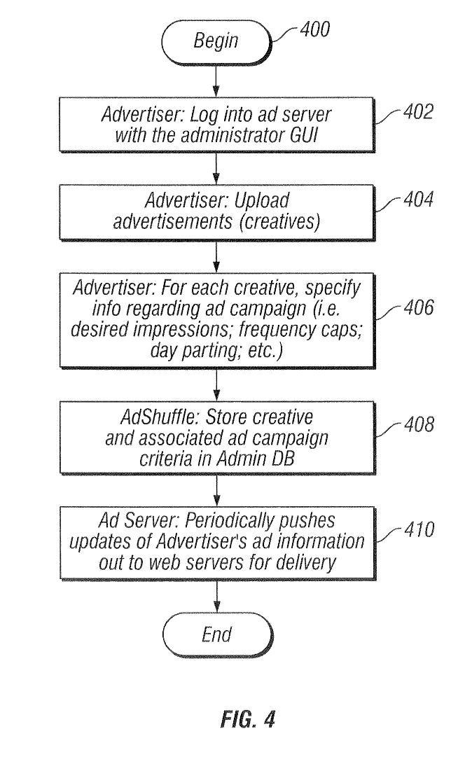

Referring to FIG. 4, the advertiser accesses the collaborative interface to view the ad campaigns that are available for a given publisher (step 402). After uploading the creatives to the ad server database (step 404), the advertiser specifies the ad campaign(s) it wishes to purchase for the given block of creatives (step 406). The advertiser can then: (1) manually set parameters relating to ad serving; (2) allow the ad server to automatically optimize how the creatives are served, or (3) allow the ad server to automatically optimize how the creatives are served within parameters established by certain manually established parameters. The ad server system then stores the creatives and associated ad campaign criteria in the database (step 408). Periodically, the ad server system determines the priority of the creatives within the campaign and pushes updates of the creatives to the web servers for delivery (step 410). Although only one web server is necessary, multiple web servers are typically employed for load balancing purposes.

The system allows for access by any number of advertisers and publishers. Typically, an advertiser will want to run an ad campaign on multiple publisher websites. With the collaborative interface, the advertiser can access the system to view creative performance reports from all of the publishers that use the current ad server system. In this manner, the advertiser only needs one interface to view performance data from multiple ad campaigns over multiple publishers. Likewise, each of the publishers can access the system to view the performance data related to the particular advertiser.

Publishers can control which ad campaign data it allows the advertiser to see or manipulate. By defining entitlements, the publisher can limit the advertiser's access. For instance, if the publisher wants to make its website metrics available to the advertiser, it can define an entitlement that will allow the advertiser to access this data. Thus, the collaborative interface allows a common place for advertisers and publishers to meet and exchange data relative to a given ad campaign.

In the current embodiment, an ad campaign comprises at least one package, creative, and placement. The creative is the actual ad graphic or a URI denoting the location of the actual ad graphic. The package defines the service parameters for different creatives, such as how the creatives are served as well as how much the placements cost. The placement is the actual location on the web page where the creative is served. Both the advertiser and publisher work together to establish these service parameters.

Creative Information

In the present embodiment, each creative has various associated parameters. For example, the advertiser can provide a block of creatives for a given ad campaign and provide a weighting value for each creative within the block. This weighting value can be used by the ad server optimizer to determine which creative will be shown in a given placement. Or, the weighting value can be used to establish a manual priority for determining which ad to serve within the block of ads.

The advertiser can also establish goal weighting for a given creative. For example, the goals may comprise: where a creative is shown; what demographic it is shown to; how often the creative is shown; the desired number of impressions; frequency caps; spending caps; day parting; or how much the advertiser is willing to spend to show the creative. The advertiser can also establish a weighting value for each of these goals.

Placement Information

In the present embodiment, specific parameters can also be established with regards placement of creatives. For example, an advertiser can establish targeting goals for creatives (i.e., demographic, geographic, publisher website type, etc.); frequency capping; impressions per period; guaranteed minimum impressions; and time of day (or period of day) to be displayed.

Creatives can also be run in multiple placements on a given publisher's site or multiple publishers' websites. For example, placement “A” may include the banner portion of each of a publisher's web pages while placement “B” may include the center portion of the homepage as well as the left side frame of the remaining pages. The advertiser can specify that a particular creative in a block of creatives is to run on placements “A” and “B” while all the other ads are to run on placement “A” only. The grouping of multiple placements is known as a “package.”

The publisher, since it owns the site that will ultimately display a given creative, has more control over the ad serving process than the advertiser. In an effort to control objectionable content, the publisher can use the collaborative interface to monitor the creatives that are being placed on its pages. If objectionable content is present, the publisher can block the content from display. However, the creative and its parameter settings are controlled by the advertiser.

Ad Optimization

The current embodiment provides advertisers with the ability to automatically optimize their creatives within a placement. Creatives performing the best based on goals and factors that the advertiser provides the optimizer are weighted higher and served more often than other creatives. Conversely, poorly performing creatives are weighted lower and are not served as often. The advertiser even has the ability to set the optimizer to pull creatives completely out of rotation so as to not get served at all.

Prior to adjusting the priority of a creative, the optimizer considers impressions, clicks, and user actions to establish a baseline number for the creative. In addition, the advertiser can set the optimizer to consider advertiser-supplied goals and goal weights when optimizing the priority so as to provide a “learning curve” for the optimizer. The advertiser can also set the frequency that the optimizer adjusts the creatives after each pass. For instance, the advertiser can set the optimizer to adjust priority every two minutes. Because the optimizer looks at the history of the performance of each creative, the advertiser can also set the range of performance data that the optimizer will consider. The optimizer's maximum and minimum effect range can be adjusted as well.

Ad Prioritization

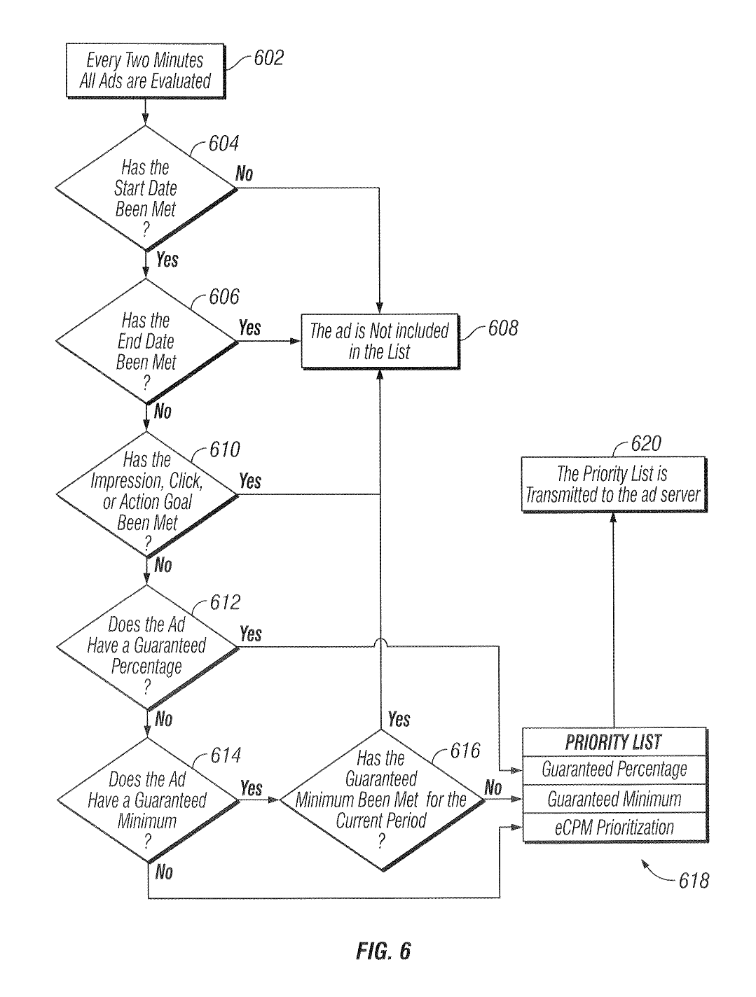

In one embodiment, as highlighted in FIG. 6, ad prioritization occurs with a fixed period. Every two minutes the system evaluates each ad that has been configured in the system and decides which ones are appropriate for service during the next two-minute period (step 602). First, some ads are excluded (step 608), such as: ads with a start date/time that has not yet elapsed (step 604); ads with an end date/time that has already elapsed (step 606); and ads with a service goal (impressions, clicks, or actions) that has been completely satisfied (step 610).

Ads that are acceptable for service and have been configured by the user with a guaranteed percentage (i.e., the creative will be shown at least the guaranteed percentage number of times overall) are placed into the first section of the Priority List (step 612). Next, ads with a guaranteed minimum number of impressions are placed into the second section of the Priority List if they are suitable for service during the upcoming period (step 614). One skilled in the arts will appreciate that this period can be adjusted without straying from the inventive concept. The guaranteed minimum number of impressions (“GM”) is the amount of service that the ad has yet to complete divided by the number of periods it has left to complete the service to compute a service-per-period figure. Ads that have already met or exceeded the service-per-period number during the current period are not included in the Priority List (step 616). However, ads that have not met their service-per-period number for the current period are included in the Priority List. Ads are placed in descending order by their calculated service-per-period numbers within the GM section of the Priority List (step 618).

Other ads that are appropriate for service are included in the third section of the Priority List, or Effective Cost per Thousand (“eCPM”) Prioritization section (step 618). The revenue generated by the ad (as impressions, clicks, or actions) is divided by the number of impressions it has served and then multiplied by 1000 to calculate the ads eCPM number. Within this section, ads are placed in descending order by their calculated eCPM number.

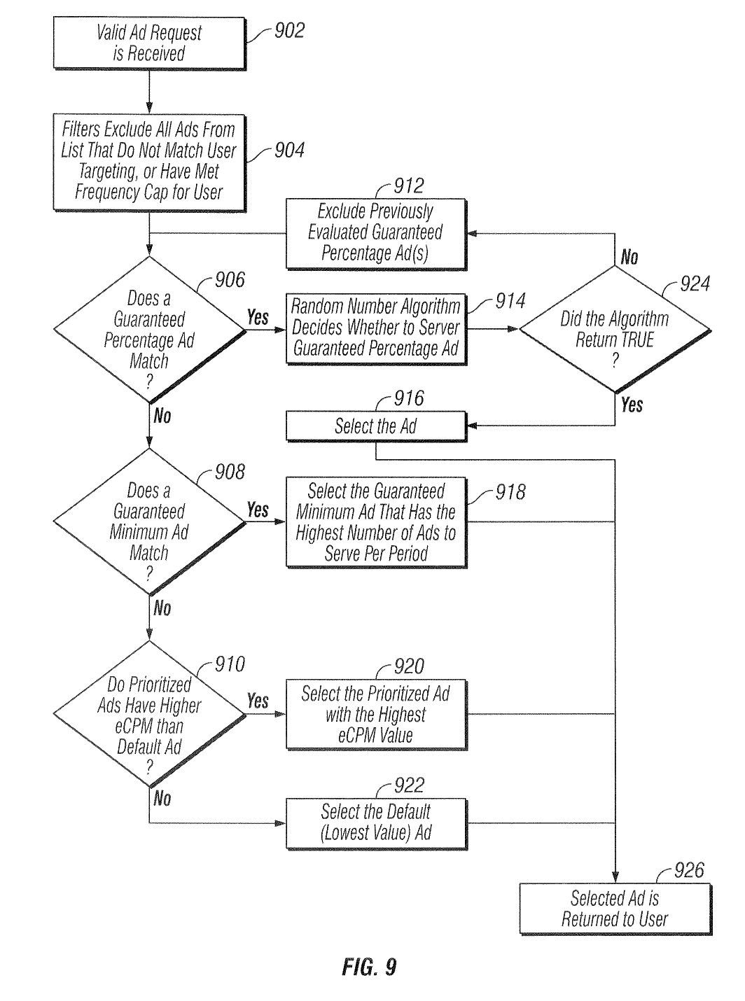

FIG. 9 illustrates steps taken by the present embodiment when selecting a prioritized ad for service. After each ad in the system has been evaluated and either excluded from consideration or placed into one of the three sections of the Priority List, the Priority List is used to govern ad service during the upcoming period.

The system uses the Prioritized List to calculate which ad is the best choice to serve in response to each valid ad request that is received. The system first checks to see if the request is valid (step 902). Requests that are malformed, lack the proper parameters or contain invalid parameters are not evaluated for ad selection. Next, filters identify all ads in the Prioritized List that are inappropriate for service to the specific user and exclude them from the evaluation. This includes targeted ads that do not match the visitor's parameters and frequency capped ads for which the visitor has already satisfied the cap conditions (step 904).

Next, guaranteed percentage ads are evaluated to determine if any match the request (step 906). A random number calculation decides whether to serve the ad to the visitor or not (step 914). This evaluation continues (step 924) until all matching guaranteed percentage ad is selected (step 916) or all have been evaluated and rejected (step 912).

If no guaranteed percentage ad has been selected, then guaranteed minimum ads are evaluated next (step 908). The system selects the first matching guaranteed percentage ad (which should have the highest computed service-per-period number) (step 918). Since the selected ad matches the target and has passed the filters that would have excluded it if it were otherwise not appropriate, the ad is acceptable to serve the request (step 926).

If no guaranteed minimum ads were available, the system then evaluates eCPM prioritized campaigns that users have entered (step 910). The system selects the first matching eCPM prioritized ad (which should have the highest computed eCPM value) (step 920). Since the selected ad matches the target and has passed the filters it is acceptable for service to this request. In the event that a user does not configure an eCPM prioritized campaign, a default campaign is always available for each location and is served (step 922).

Creative Repository/Bank

In another embodiment of the present invention, creatives are stored in a creative repository, or “bank.” Within this bank are records representing various elements of a given creative. This allows an advertiser to tie elements of the creative to its performance. For example, each creative in a given block of creatives might have an element noting the hair color of the subject of the creative. Thus, if an ad campaign features a blonde in one instance, a brunette in another instance, and a red head in yet another, it would be possible to track which particular hair color generated the most positive performance for the creative. Likewise, an element regarding different phrasings of a given advertisement could track which particular phrase performed best.

In another embodiment, the bank, in conjunction with each creative, contains records representing elements of each website that displays the given creative. This allows an advertiser to tie elements of the website to the creative to evaluate the website's performance with the given creative. For example, the website element that is monitored could be the type of industry which it is targeted towards (i.e., financial website, sports website, etc.). Such an element might inform the advertiser that “creatives featuring women perform better on sports websites,” or that “blondes get the most attention on finance sites.”

Pixel Management

In yet another embodiment, the ad server provides the advertiser with a small block of code that goes on the page where they are tracking actions. This allows the advertiser to manage the publishers tracking pixels in the ad server instead of in the page code. The ad server makes the decision as to which publisher pixel is fired for that action instead of all publisher pixels being fired after the action has occurred.

This embodiment relies on a server process that receives cookie data from a single tracking asset and correlates it with all of the data that each participating publisher has entered through the collaborative interface. Using this data, the system identifies which publisher(s) action tracking assets are needed for the specific visitor. The system then prepares a response that contains each of the tracking assets of these relevant publishers and returns it to the visitor.

A software program provides a method for measuring visitor actions that occur after viewing or clicking an online advertisement served from one of multiple publisher websites. This software allows advertisers to track the actions with a single action-tracking asset (http URI addresses), rather than requiring multiple assets. This is accomplished by storing each publisher's action tracking pixel URI within the advertiser online ad management system rather than placing it directly on the advertiser action completion page. The system logic that is used to manage ad views and clicks for ads served to the various publisher sites is extended to also track what action tracking assets correspond to the visitor experience at any given time. The single advertiser action tracking asset is then extended to include any and all action tracking assets for the appropriate publishers only.

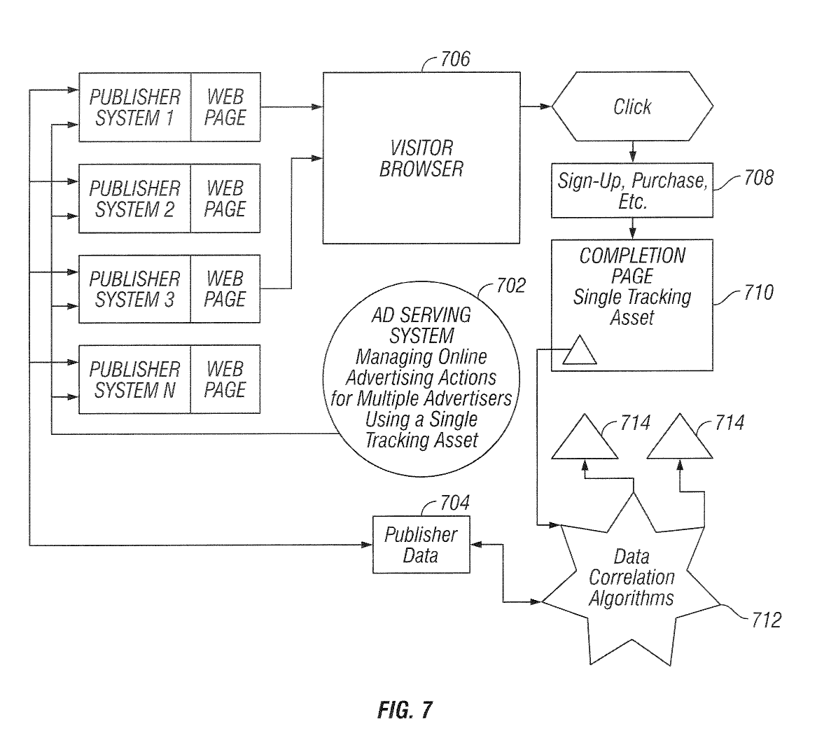

FIG. 7 presents a block diagram showing the steps taken by this embodiment with regards to asset tracking. First, an advertiser contracts with multiple publishers to serve its ads 702. The publishers are supplied ad tags that they enter into their ad management systems for service onto Web pages. Next, the publishers supply the advertiser with actions tracking asset URI values (with the expectation that the advertiser will place each action tracking asset onto the completion page associated with the advertisements) 704. Rather than place these action tracking assets onto the page, the advertiser enters them into the management system via the user interface. The ads and associated cookies are then delivered to Web visitors by one or more Web site publishers. The site(s) involved may change over time.

When online visitors view the ads 706, some will click on them and ultimately complete the action being encouraged by the promotion (i.e., online purchase, newsletter sign-up or other online process) 708. Once the desired response is received, visitors are shown a page that includes the single tracking asset 710. The system then receives the request for the tracking asset and the cookie data issued during service of the creative. The software then uses internal data and algorithms to correlate this data with the publisher configuration data and tracking assets configured earlier and determine which publisher tracking assets are appropriate for the visitor that completes the action at that time 712. Finally, the response to the single system tracking asset is used to insert any appropriate publisher tracking assets onto the page dynamically 714.

Exchange

In the present embodiment, both advertisers 106 and publishers 104 can access the system through a common collaborative interface. With the common interface and comprehensive near real-time metric gathering, the system can be readily utilized to perform auctions of a publisher's inventory.

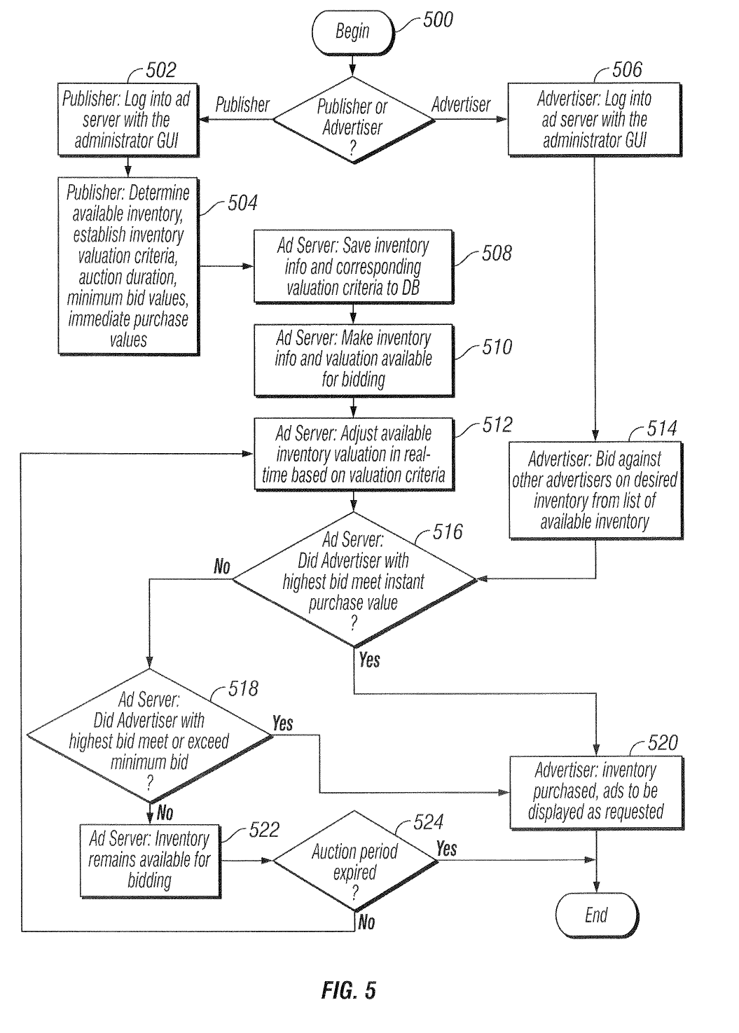

FIG. 5 provides a flow diagram illustrating the steps performed by publishers 104 and advertisers 106 in conducting such an auction. To begin, an auction requires inventory to be auctioned. The publisher logs into the collaborative interface (step 502); determines available inventory; creates campaigns; establishes valuation criteria; and sets minimum bid values and optional immediate purchase values (step 504). One skilled in the art will appreciate that the actual types of data input by the publisher in this step can vary without straying from the inventive concept.

Once the publisher inventory and campaign criteria are set, the ad server stores the data in the database 114 (step 508) and makes the inventory available for bidding (step 510). Next, any number of advertisers may log into the system (step 506) to bid on the available inventory (step 514).

As bids are placed, the ad server compares the bid prices to the instant purchase value (step 516). If the high bid is equal to or greater than the instant purchase value, the bidder has purchased the desired inventory (step 520). If lower, the highest bid that meets or exceeds the established minimum bid value (step 518) has purchased the desired inventory (step 520). If no advertiser has bid higher than the minimum bid value, the inventory remains up for auction until the specified time period has expired (steps 522 and 524).

As time progresses, valuation of a given inventory may change in real time. For instance, a given piece of inventory may accumulate 1,000,000 impressions over a given period. The publisher may auction the entire block of impressions, or may break it into portions. Thus, an advertiser may purchase 500,000 impressions and leave 500,000 to be auctioned. Because the present embodiment compiles and makes available metric data as it is generated, valuation logic can monitor the metric data and adjust (in real time or near real time) the minimum bid and immediate purchase value criteria (step 512).

Because the present embodiment allows real time or near real time valuation criteria, it is possible for a publisher to place inventory up for perpetual auction. For example, an advertiser may purchase 1,000,000 impressions over a given period. Once the period has expired, the impressions again become available and can immediately reenter the auction process without additional interaction by the publisher. The publisher can, periodically, log into the system to adjust any of the valuation criteria as necessary or can chose to allow the system logic to handle valuation.

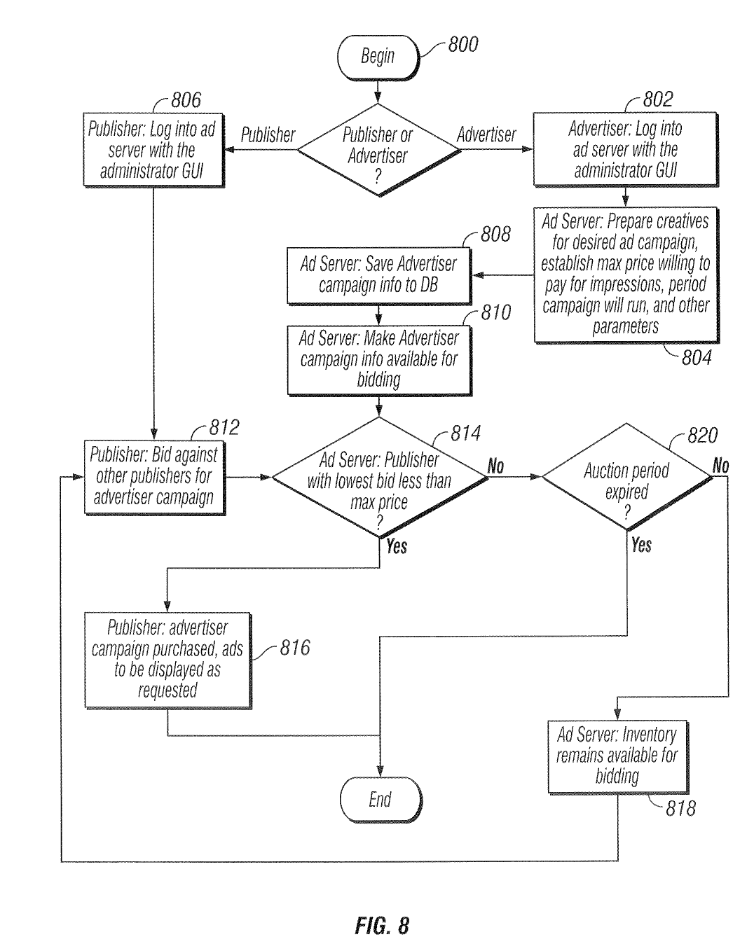

In another embodiment, as represented by FIG. 8, the system allows the advertisers and publishers to collaborate in a reverse-type auction (step 800). This type of auction allows an advertiser to present a proposed ad campaign and have multiple publishers bid to see who will host it for the least cost.

First, the advertiser logs into the ad server (step 802) and prepares the proposed ad campaign by uploading the creatives, specifying the important campaign parameters (i.e., duration, time/date, demographics, type of publisher, etc.) (step 804). The ad server saves the campaign information in the database (step 808) and makes the campaign available for bidding (step 810). Publishers log into the interface (step 806) and bid against one another for the campaigns (step 812). Only bids less than or equal to the advertiser's specified maximum acceptable price will be considered (step 814). If no bids satisfy the maximum amount, the campaign stays active (step 818) as long as the bidding period has not yet expired (step 820). The publisher with the lowest bid price will win the auction (step 816).

It will now be evident to those skilled in the art that there has been described herein an improved system and method for managing online advertising inventory and creatives. Although the invention hereof has been described by way of a preferred embodiment, it will be evident that other adaptations and modifications can be employed without departing from the spirit and scope thereof. For example, the publisher could function as the ad server in yet another embodiment. Also, the different functions (web server, ad server, and database), although shown as separate machines, can be combined to run on fewer than three machines.

The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A system, the system for collaboratively managing internet ad campaigns, the ad campaigns comprising advertising creatives, the system providing collaborative access by a plurality of advertisers and a plurality of publishers, the system for serving an advertiser's ad campaign for placement of creatives within one or more of the publishers' web pages, the system comprising:
at least one computer;
at least one database;
at least one web server; and
an interface, wherein the interface allows for common access to the system by both the advertisers and the publishers, and wherein the interface allows the advertisers and publishers to share information related to at least one ad campaign.

2. The system of claim 1 wherein the interface allows the advertiser to view performance metrics related to the ad campaign.

3. The system of claim 2 wherein the ad campaign is served by one or more publishers.

4. The system of claim 1 wherein each ad campaign comprises:
at least one creative;
at least one package; and
at least one placement, and
wherein the interface allows at least one advertiser and at least one publisher to view and manipulate the ad campaign.

5. The system of claim 1 wherein entitlements are used to control an advertiser's access to at least one publisher's data pertaining to the advertiser's ad campaign.

6. The system of claim 1 wherein the advertisers and publishers collaborate in an auction of publisher inventory.

7. The system of claim 1 wherein the interface allows advertisers and publishers to collaborate in an auction of publisher inventory.

8. The system of claim 1 wherein the interface allows the advertiser to manage all advertiser controlled elements of an ad campaign.

9. The system of claim 1 wherein the interface allows the publisher to manage all publisher controlled elements of an ad campaign.

10. The system of claim 1 wherein the ad campaign is stored in at least one database, and wherein a prioritized list of creatives within the ad campaign is pushed to each web server on a periodic basis.

11. A method, the method for collaboratively managing internet ad campaigns using the system of claim 1, the ad campaigns comprising advertising creatives, the method providing collaborative access by a plurality of advertisers and a plurality of publishers, the method for serving an advertiser's ad campaign for placement of creatives within one or more of the publishers' web pages, the method comprising the following steps:
accepting a first ad campaign data from at least one publisher concerning the publisher's inventory;
accepting a second ad campaign data from at least one advertiser concerning the advertiser's at least one ad campaign; and
conducting the ad campaign in accordance with the parameters specified by the first ad campaign data and the second ad campaign data.

12. The method of claim 11 further comprising the following step:
displaying ad campaign performance metrics associated with an advertiser's creatives.

13. The method of claim 11 further comprising the following step:
displaying ad campaign performance metrics associated with a publisher's inventory.

14. The method of claim 11 wherein each ad campaign comprises:
at least one creative;
at least one package; and
at least one placement, and
wherein the interface allows an advertiser and at least one publisher to view and manipulate the ad campaign.

15. The method of claim 11 wherein entitlements are used to control an advertiser's access to at least one publisher's data pertaining to the advertiser's ad campaign.

16. The method of claim 11 wherein the advertisers and publishers collaborate in an auction of publisher inventory.

17. The method of claim 11 wherein the interface allows advertisers and publishers to collaborate in an auction of ad campaigns.

18. The method of claim 11 wherein the interface allows the advertiser to manage all advertiser controlled elements of an ad campaign.

19. The method of claim 11 wherein the interface allows the publisher to manage all publisher controlled elements of an ad campaign.

20. The method of claim 11 wherein the ad campaign is stored in at least one database, and wherein a prioritized list of creatives within the ad campaign is pushed to each web server on a periodic basis.

21. A computer program product comprising a computer-readable medium having instructions, the instructions being operable to enable a computer to execute a procedure for performing the method of claim 11, the program instructions comprising:
accepting a first ad campaign data from at least one publisher concerning the publisher's inventory;
accepting a second ad campaign data from at least one advertiser concerning the advertiser's at least one ad campaign; and
conducting the ad campaign in accordance with the parameters specified by the first ad campaign data and the second ad campaign data.

22. The computer program product of claim 21, the program instructions further comprising:
displaying ad campaign performance metrics associated with an advertiser's creatives.

23. The computer program product of claim 21, the program instructions further comprising:
displaying ad campaign performance metrics associated with a publisher's inventory.

24. The computer program product of claim 21 wherein each ad campaign comprises:
at least one creative;
at least one package; and
at least one placement, and
wherein the interface allows an advertiser and at least one publisher to view and manipulate the ad campaign.

25. The computer program product of claim 21 wherein entitlements are used to control an advertiser's access to at least one publisher's data pertaining to the advertiser's ad campaign.

26. The computer program product of claim 21 wherein the advertisers and publishers collaborate in an auction of publisher inventory.

27. The computer program product of claim 21 wherein the interface allows advertisers and publishers to collaborate in an auction of ad campaigns.

28. The computer program product of claim 21 wherein the interface allows the advertiser to manage all advertiser controlled elements of an ad campaign.

29. The computer program product of claim 21 wherein the interface allows the publisher to manage all publisher controlled elements of an ad campaign.

30. The computer program product of claim 21 wherein the ad campaign is stored in at least one database, and wherein a prioritized list of creatives within the ad campaign is pushed to each web server on a periodic basis.
